(19) United States
(12) Patent Application Publication
(10) Pub. No.: US 2025/0371794 A1
(43) Pub. Date: Dec. 4, 2025

(54) VIRTUAL TERRAIN RENDERING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Bowen YU, Shenzhen (CN)

(21) Appl. No.: 19/303,270

(22) Filed: Aug. 18, 2025

Related U.S. Application Data
(63) Continuation of application No. PCT/CN2024/100116, filed on Jun. 19, 2024.

(30) Foreign Application Priority Data
Aug. 30, 2023 (CN) 202311102281.7

(51) Int. Cl. G06T 15/20

(52) U.S. Cl. CPC G06T 15/20; G06T 2210/36

(57) ABSTRACT

A virtual terrain rendering method is performed by a computer device. The method includes: in response to a virtual terrain rendering instruction, determining virtual terrain data of a plurality of virtual blocks in a virtual terrain, the virtual terrain data having first and second levels of detail, and a degree of detail represented by the first level of detail being lower than a degree of detail represented by the second level of detail; determining, among the plurality of virtual blocks, at least one visible virtual block and respective target levels of detail of the at least one visible virtual block based on an orientation of a virtual camera; and rendering the virtual terrain based on the virtual terrain data of the at least one visible virtual block at the respective target levels of detail.

### CROSS-REFERENCE TO RELATED APPLICATIONS

This application is a continuation application of PCT Patent Application No. PCT/CN2024/100116, entitled “VIRTUAL TERRAIN RENDERING METHOD AND APPARATUS, DEVICE, STORAGE MEDIUM, AND PROGRAM PRODUCT” filed on Jun. 19, 2024, which claims priority to Chinese Patent Application No. 202311102281.7, entitled “VIRTUAL TERRAIN RENDERING METHOD AND APPARATUS, DEVICE, STORAGE MEDIUM, AND PROGRAM PRODUCT” filed on Aug. 30, 2023, both of which are incorporated by reference in their entirety.

### FIELD OF THE TECHNOLOGY

Embodiments of this application relate to the field of virtual environments, and in particular, to a virtual terrain rendering method and apparatus, a device, a storage medium, and a program product.

### BACKGROUND OF THE DISCLOSURE

Nowadays, with the development of technology, technologies such as visual simulation, virtual simulation, and virtual reality simulation are gradually applied in the field of flight simulation. Advanced technologies such as a computer technology, a graphic image technology, and an optical technology are integrated to implement three-dimensional modeling of the real or imagined virtual world, which is displayed through displays or projectors.

In the related art, in a flight simulation application process, an enhanced flight vision system needs to perform terrain rendering. In a rendering process, a user needs to determine a flight region in advance, and can enter flight training only after the enhanced flight vision system loads terrain data corresponding to the flight region.

However, in the related art, a pre-loading strategy for terrain data requires the flight region to be determined in advance. Consequently, the user can only perform training in a pre-selected region in one training process, resulting in poor applicability of the terrain loading solution.

### SUMMARY

Embodiments of this application provide a virtual terrain rendering method and apparatus, a device, a storage medium, and a program product. The technical solutions provided in the embodiments of this application include the following aspects.

According to an aspect, an embodiment of this application provides a virtual terrain rendering method performed by a computer device. The method includes the following operations:

in response to a virtual terrain rendering instruction, determining virtual terrain data of a plurality of virtual blocks in a virtual terrain, the virtual terrain data having first and second levels of detail, and a degree of detail represented by the first level of detail being lower than a degree of detail represented by the second level of detail;

determining, among the plurality of virtual blocks, at least one visible virtual block and respective target levels of detail of the at least one visible virtual block based on an orientation of a virtual camera; and

rendering the virtual terrain based on the virtual terrain data of the at least one visible virtual block at the respective target levels of detail.

According to another aspect, an embodiment of this application provides a computer device. The computer device includes a processor and a memory, the memory having a computer program stored therein, the computer program being loaded and executed by the processor and causing the computer device to implement the foregoing virtual terrain rendering method.

According to another aspect, a non-transitory computer-readable storage medium is provided. The computer-readable storage medium has a computer program stored therein, the computer program being loaded and executed by a processor to implement the foregoing virtual terrain rendering method.

According to another aspect, an embodiment of this application provides a computer program product. The computer program product includes a computer program, the computer program being stored in a non-transitory computer-readable storage medium. A processor of a computer device reads the computer program from the computer-readable storage medium, and the processor executes the computer program, to enable the computer device to perform the foregoing virtual terrain rendering method.

Beneficial effects brought by the technical solutions provided by embodiments of this application include at least the following content.

In a virtual terrain loading process, virtual terrain data of all virtual blocks in the virtual terrain at the first level of detail having the lowest degree of detail is persistently loaded into the memory, and after the target level of detail of each visible virtual block within the visible range is determined, virtual terrain data of each visible virtual block at the target level of detail is dynamically loaded into the memory. The virtual terrain data of the virtual block at the first level of detail is persistently loaded, and the virtual terrain data of the visible virtual block at the target level of detail is dynamically loaded. Loading virtual terrain data of different blocks at different levels of detail in this asynchronous dynamic loading manner is beneficial to dynamically adjusting the degree of detail of the generated virtual terrain based on the orientation of the virtual camera in the virtual terrain loading process, which better conforms to the way the human eye perceives objects in reality. In addition, the asynchronous dynamic loading manner for the virtual terrain data achieves a higher degree of intelligence compared with pre-loading virtual terrain information on fixed routes and determining terrain meshes, and the terrain loading solution achieves wider usage scenarios.

### BRIEF DESCRIPTION OF THE DRAWINGS

FIG. 1 is a schematic diagram of an implementation environment according to an exemplary embodiment of this application.

FIG. 2 is a schematic diagram of an application interface for virtual terrain rendering according to an exemplary embodiment of this application.

FIG. 3 is a schematic diagram of a virtual terrain rendered through a virtual terrain rendering solution according to an exemplary embodiment of this application.

FIG. 4 is a flowchart of a virtual terrain rendering method according to an exemplary embodiment of this application.

FIG. 5 is a schematic diagram of imaging effects of different blocks within a visible range on an imaging plane according to an exemplary embodiment of this application.

FIG. 6 is a schematic diagram of a quadtree structure according to an exemplary embodiment of this application.

FIG. 7 is a schematic diagram of target levels of detail of visible virtual blocks at different projection distances according to an exemplary embodiment of this application.

FIG. 8 is a schematic diagram of dynamically loading virtual terrain data according to an exemplary embodiment of this application.

FIG. 9 is a structural block diagram of a virtual terrain rendering apparatus according to an exemplary embodiment of this application.

FIG. 10 is a schematic structural diagram of a computer device according to an exemplary embodiment of this application.

### DESCRIPTION OF EMBODIMENTS

To make the objectives, technical solutions, and advantages of this application clearer, the following further describes embodiments of this application in detail with reference to the accompanying drawings.

The computer vision (CV) technology is a science that studies how to make a machine “see”. Further, the computer vision technology refers to using a camera and a computer to replace human eyes to perform machine vision such as recognition, following, and measurement on a target, and further perform graphics processing, so that the computer processes an image that is more suitable for human eyes, to observe or transmit the image to an instrument for detection. As a scientific discipline, theories and technologies related to a computer vision research attempt to establish an artificial intelligence system that can obtain information from an image or multi-dimensional data. The computer vision technologies generally include technologies such as image processing, image recognition, image semantic understanding, image retrieval, optical character recognition (OCR), video processing, video semantic understanding, video content/behavioral recognition, three-dimensional object reconstruction, a three-dimensional (3D) technology, virtual reality, augmented reality, simultaneous positioning, and map construction, and further include common biometric recognition technologies such as face recognition and fingerprint recognition.

A terrain is a general term for the shapes of land features and landforms, specifically referring to the various states of high and low undulations exhibited by fixed objects distributed above the Earth's surface.

A virtual terrain refers to terrain structures constructed in a virtual environment based on terrain features. The terrain features include terrain elevation, surface textures, and the like, which can reflect spatial relationships, spatial positions, and the like of geographic elements. Virtual terrain generation requires extensive collaboration of matrices to generate information such as terrain elevation and textures, and is a basic prerequisite in a terrain generation module of an engine or a game.

A terrain mesh refers to a structure of equidistant vertices constituting the terrain on the Earth's surface. In a virtual terrain generation process, it is necessary to generate meshes having more complex vertices. The terrain mesh is constructed through a continuous level of detail (CLoD) algorithm, and may be simply considered as a dynamic polygon mesh that provides more vertex regions and greater detail.

A block is a geological block that has a comprehensive structural form and belongs to a tectonic system.

A virtual block refers to a part of a block range divided according to rules in the virtual terrain, and a plurality of virtual blocks are included in a complete range of the virtual terrain.

A level of detail (LoD) is a commonly used optimization manner in large scene development, and its a core is that three-dimensional model objects in a scene display different degrees of detail based on their distances from a virtual camera, a models closer to the camera display a higher degree of detail, and models farther away display a lower degree of detail, thereby reducing overheads of performance.

A quadtree is a tree data structure in which each node has four tiles. The quadtree is usually used for analysis and classification of two-dimensional spatial data. In this embodiment of this application, different target levels of detail are organized through a quadtree structure.

Rendering refers to a process of generating an image from a model through software. The model is a description of a three-dimensional object or virtual scene strictly defined by using language or data structures, including information such as geometry, viewpoint, texture, lighting, and shadows. The generated image is a digital image or a bitmap image.

A game engine refers to reusable core components of some interactive real-time image applications, providing a series of visual development tools. It generally includes a rendering engine, a physics engine, a collision detection system, audio, a script engine, computer animation, artificial intelligence, a network engine, scene management, and the like.

FIG. 1 is a schematic diagram of an implementation environment according to an exemplary embodiment of this application. The implementation environment includes a terminal 110 and a server 120. The terminal 110 performs data communication with the server 120 through a communication network. In some embodiments, the communication network may be a wired network or a wireless network, and the communication network may be at least one of a local area network, a metropolitan area network, or a wide area network.

The terminal 110 is an electronic device having a virtual terrain rendering function. The electronic device may be a mobile terminal such as a smartphone, a tablet computer, or a laptop computer, or may be a terminal such as a desktop computer or a projection-based computer. This is not limited in this embodiment of this application. In addition, the terminal may provide a virtual terrain rendering function through an application such as a game application, a virtual reality simulation application, a map application, or a flight simulator application. This is not limited in this application.

The server 120 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The server 120 is configured to provide backend services for an application supporting virtual terrain rendering. In some embodiments, the server 120 undertakes primary computing work, and the terminal 110 undertakes secondary computing work; or the server 120 undertakes secondary computing work, and the terminal 110 undertakes primary computing work; or a distributed computing architecture is used between the server 120 and the terminal 110 to perform collaborative computing.

As shown in FIG. 1, when virtual terrain rendering is required, the terminal 110 persistently loads, in response to a terrain rendering instruction, virtual terrain data at a first level of detail into a memory; determines a target level of detail; and dynamically loads the virtual terrain data at the target level of detail into the memory, to render a virtual terrain based on the virtual terrain data. In this implementation, the virtual terrain data may be stored in an external memory, and the terminal 110 obtains the virtual terrain data from the external memory and loads the virtual terrain data into the memory.

In a possible implementation, the server 120 stores data at different levels of detail corresponding to virtual blocks in the virtual terrain, the terminal 110 obtains, in response to the terrain rendering instruction, the virtual terrain data at the first level of detail from the server 120, and after determining the target level of detail, the terminal 110 obtains virtual terrain data of the visible virtual block at the target level of detail from the server 120.

In some embodiments, the terminal 110 may transmit data of blocks under a current perspective of a virtual camera to the server 120, and the server 120 determines target levels of detail of different visible virtual blocks based on an orientation of the virtual camera.

For ease of description, the following embodiments are described by using an example in which the virtual terrain rendering method is performed by a computer device. The computer device may be the terminal 110 or the server 120 introduced above.

In some embodiments, the virtual terrain rendering method provided in this embodiment of this application may be applied to a product having a virtual terrain rendering function, for example, a product such as a flight simulator, a driving simulator, or a ship simulator.

In some embodiments, the virtual terrain rendering method provided in this embodiment of this application may be applied to the flight simulator. In a flight simulation process of a pilot through the flight simulator, the computer device may render virtual terrain based on high-precision global terrain data in an asynchronous dynamic loading manner for virtual terrain data, and project a virtual terrain picture onto a display screen of the flight simulator based on a mapping relationship from three-dimensional virtual space to two-dimensional image space.

For example, the virtual terrain rendering method provided in this application is applied to an enhanced flight vision system (EFVS) of a full flight simulator (FFS). The FFS is high-precision and advanced technical equipment in the field of flight manufacturing, and can realistically simulate aircraft flight attitudes and maneuvers such as takeoff and landing, and special situations, providing a user with a sensory effect of simulating a real environment through a virtual environment. The enhanced flight vision system, as a sub-system of the FFS, is configured to provide visual information to the user, and includes an imaging display device and a simulation rendering engine.

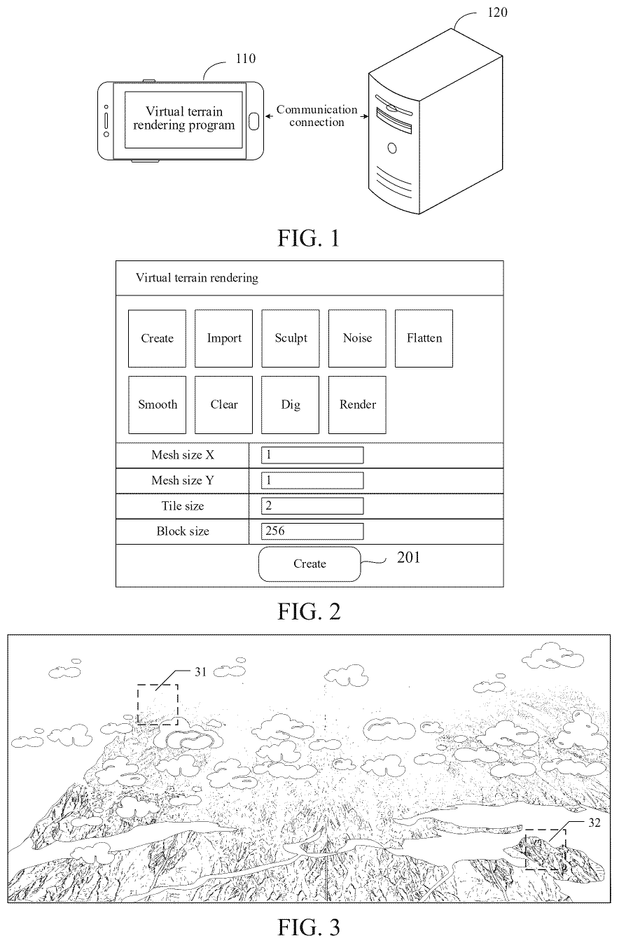

FIG. 2 is a schematic diagram of an application interface for virtual terrain rendering according to an exemplary embodiment of this application. The application supports functions such as creation, importing, modeling (that is, sculpting), clearing, digging (that is, excavating), and rendering. In addition, the interface further displays a terrain size setting control, a block size setting control, and a tile size setting control. A user may modify virtual terrain data by triggering the corresponding controls. In addition, after setting corresponding parameters, the user may trigger a creation control 201, enabling the terminal to a virtual terrain rendering instruction.

FIG. 3 is a schematic diagram of a virtual terrain rendered through a virtual terrain rendering solution according to an exemplary embodiment of this application. The virtual terrain from this viewpoint is the scene observed from a perspective of a virtual camera. Blocks farther from an orientation of the virtual camera (such as a virtual block 31 in the figure) have a lower degree of detail of the virtual terrain, that is, the displayed virtual terrain is coarser, and blocks closer to the virtual camera (such as a virtual block 32 in the figure) that is have a higher degree of detail of the virtual terrain, that is, the displayed virtual terrain is more detailed. The solution provided in this embodiment of this application enables the enhanced flight vision system to render a high-precision virtual terrain that approximates real terrain.

In some embodiments, the virtual terrain rendering solution provided in this embodiment of this application is applied to a driving simulator. In a simulated driving process of a driver through the driving simulator, the computer device may render virtual road condition terrain based on the virtual road condition data in an asynchronous dynamic loading manner for virtual terrain data, and project a virtual driving picture onto a display screen of the driving simulator based on a mapping relationship from three-dimensional virtual space to two-dimensional image space.

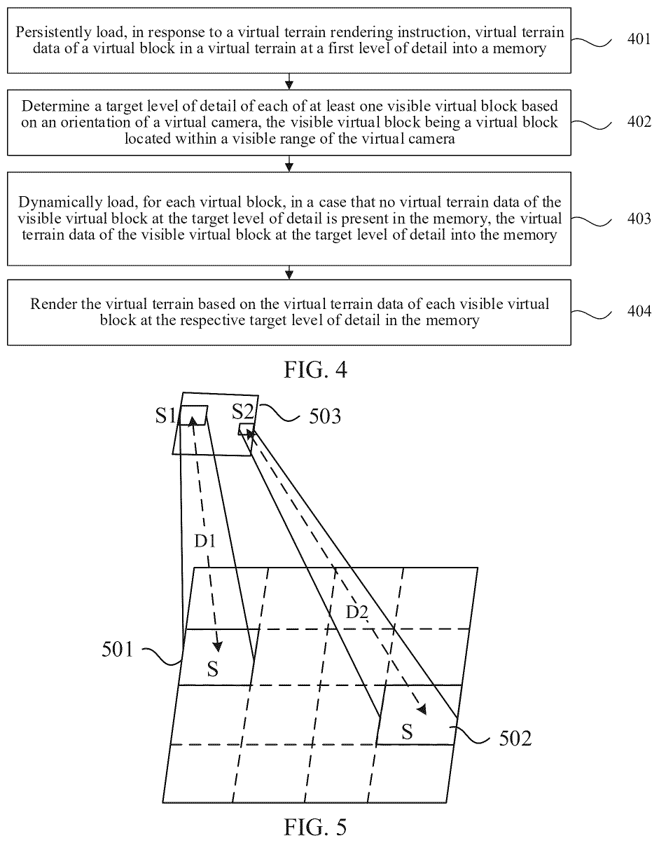

FIG. 4 is a flowchart of a virtual terrain rendering method according to an exemplary embodiment of this application. This embodiment is described by using an example in which the method is performed by a computer device. The method includes the following operations.

Operation 401: Persistently load, in response to a virtual terrain rendering instruction, virtual terrain data of a virtual block in a virtual terrain at a first level of detail into a memory.

In some embodiments, the virtual terrain includes a plurality of virtual blocks. For example, the virtual terrain includes a plurality of virtual blocks distributed in an array, for example, including M×N virtual blocks, where M and N are arbitrary positive integers. For each virtual block, the virtual block supports at least two levels of detail, that is, the virtual block has virtual terrain data at least two levels of detail. In addition, a degree of detail represented by the first level of detail is lower than a degree of detail represented by another level of detail, where the another level of detail refers to a level of detail other than the first level of detail in the at least two levels of detail. The first level of detail is a level of detail having the lowest degree of detail in the at least two levels of detail.

In a possible implementation, considering that a virtual terrain rendering scenario is a three-dimensional virtual scene, and the projected virtual terrain is presented as a two-dimensional picture, to achieve projected display of the three-dimensional virtual scene, the computer device sets a virtual viewpoint in a target virtual scene, and observes the target virtual scene based on the virtual viewpoint, to simulate a perspective effect of observing the projected picture based on a user viewpoint in real physical space. In some embodiments, the virtual viewpoint may be simulated through a camera model, that is, a virtual scene is observed through a virtual camera model. In addition, the target virtual scene may be any three-dimensional virtual scene for projected display.

An application supporting virtual terrain rendering is installed in the computer device. A user triggers the virtual terrain rendering instruction through the application, and the computer device starts to load the virtual terrain data in response to the virtual terrain rendering instruction.

In this embodiment of this application, the virtual terrain is loaded in an asynchronous dynamic loading manner. Since in a virtual terrain rendering process, the rendered virtual terrain may have different degrees of detail, the first level of detail, as a level of detail having the lowest degree of detail, has corresponding virtual terrain data that occupies less memory resources, and blocks at the first level of detail account for a large proportion in the rendered virtual terrain. Therefore, virtual terrain data of all virtual blocks in the entire terrain in the rendered virtual terrain is persistently loaded into the memory. During terrain rendering, the memory may be accessed to obtain a part of the virtual terrain data at the first level of detail within a visible range.

In addition, it enables virtual terrain data of a visible virtual block within the visible range at the first level of detail to be quickly accessed from the memory as a perspective of a virtual camera continuously changes. For example, if there is a first virtual block within the visible range from the perspective of the virtual camera, and a target level of detail of the first virtual block is the first level of detail under the current perspective, during rendering of the virtual terrain, the computer device may determine a memory space address of virtual terrain data of the first virtual block at the first level of detail. Therefore, the computer device accesses a corresponding memory unit based on the address, to obtain the virtual terrain data of the first virtual block at the first level of detail and then render the virtual terrain. When the perspective of the virtual camera changes, if there is a second virtual block within the visible range, and a target level of detail of the second virtual block is the first level of detail, during re-rendering of the virtual terrain, the computer device determines a memory space address of virtual terrain data of the second virtual block at the first level of detail, and accesses memory space indicated by the address, to render the virtual terrain of the second virtual block based on the obtained virtual terrain data of the second virtual block at the first level of detail.

Operation 402: Determine a target level of detail of each of at least one visible virtual block based on an orientation of a virtual camera, the visible virtual block being a virtual block located within the visible range of the virtual camera.

The orientation of the virtual camera includes a position of the virtual camera in a virtual environment and a camera angle (that is, a perspective) of the virtual camera. The range of virtual terrain that can be captured by the virtual camera varies in different orientations, resulting in variations in the imaging plane presented to the user in different orientations of the virtual camera.

In some embodiments, the visible range is the field of view determined in the virtual scene based on the orientation of the virtual camera. The visible range changes with the orientation of the virtual camera.

In some embodiments, the visible virtual block is a virtual block within the visible range. That is, the visible virtual block is a block captured by the virtual camera in the virtual scene. For example, the visible virtual block is a part of blocks in the virtual scene. Parameters of the virtual terrain captured by the virtual camera undergo a series of transformations and are finally projected onto the imaging plane to be presented to the user.

Since not all virtual blocks in the complete virtual terrain can be captured by the virtual camera in the orientation of the virtual camera, it is possible to render only the virtual terrain within a current visible range of the virtual camera, thereby effectively reducing a calculation amount and saving computing resources.

In an example, the computer device determines the visible range in the current orientation based on the orientation of the virtual camera through a frustum culling algorithm. For specific content related to the frustum culling algorithm, refer to the related art. Details are not described in this embodiment.

Within the visible range, according to the imaging principle imaging principle where closer objects appear larger and farther objects appear smaller, a projected area of an object close to the virtual camera on the imaging plane is large, and a projected area of an object far from the virtual camera on the imaging plane is small. Therefore, target levels of detail of different visible virtual blocks within the visible range need to be different, to achieve a more realistic imaging effect.

Since only the virtual block in the visible range needs to be rendered during rendering of the virtual terrain, and the virtual terrain rendered within the visible range is updated based on the current orientation of the virtual camera in each frame, only the target level of detail of the visible virtual block within the visible range needs to be determined, and the target level of detail of each virtual block is re-determined in each frame. Target levels of detail of at least two visible virtual blocks are the same.

Operation 403: Dynamically load, for each virtual block, when no virtual terrain data of the visible virtual block at the target level of detail is present in the memory, the virtual terrain data of the visible virtual block at the target level of detail into the memory.

The virtual terrain data of the visible virtual block at the target level of detail needs to be dynamically loaded into the memory. Therefore, when the virtual terrain data of the visible virtual block at the target level of detail is already present in the memory, the virtual terrain data of the visible virtual block at the target level of detail does not need to be dynamically loaded into the memory.

In some embodiments, when the virtual terrain data of the visible virtual block at the target level of detail is already present in the memory, if the target level of detail corresponding to the visible virtual block changes, and when virtual terrain data at the changed target level of detail is not loaded into the memory, the virtual terrain data of the visible virtual block at the changed target level of detail is loaded into the memory.

Operation 404: Render the virtual terrain based on the virtual terrain data of each visible virtual block at the respective target level of detail in the memory.

After the target level of detail is determined, the virtual terrain data of each visible virtual block within the visible range at the target level of detail is respectively extracted from the memory, and then different visible virtual blocks are rendered based on the virtual terrain data. In conclusion, in this embodiment of this application, in a virtual terrain loading process, virtual terrain data of all virtual blocks in the virtual terrain at the first level of detail having the lowest degree of detail is persistently loaded into the memory, and after the target level of detail of each visible virtual block within the visible range is determined, virtual terrain data of each visible virtual block at the target level of detail is dynamically loaded into the memory. The virtual terrain data of the virtual block at the first level of detail is persistently loaded, and the virtual terrain data of the visible virtual block at the target level of detail is dynamically loaded. Loading virtual terrain data of different blocks at different levels of detail in this asynchronous dynamic loading manner is beneficial to dynamically adjusting the degree of detail of the generated virtual terrain based on the orientation of the virtual camera in the virtual terrain loading process, which better conforms to the way the human eye perceives objects in reality. In addition, the asynchronous dynamic loading manner for the virtual terrain data achieves a higher degree of intelligence compared with pre-loading virtual terrain information on fixed routes and determining terrain meshes, and the terrain loading solution achieves wider usage scenarios.

In some embodiments, a complete terrain has a large range, for example, a global terrain. In this case, the terrain displayed to the user on the imaging plane is only a part of the complete terrain, that is, the visible range. The complete terrain includes a plurality of virtual blocks, and the virtual block within the visible range is the visible virtual block.

In the virtual terrain rendering process, since on the imaging plane captured by the virtual camera, a visible virtual block at a position closer to the virtual camera has a large imaging area on the imaging plane, that is, occupies more pixels, to ensure its imaging effect, a degree of detail of the block closer to the virtual camera needs to be higher, and a visible virtual block farther from the virtual camera needs to have a smaller projected area on the imaging plane, that is, occupies fewer pixels. Even when there may be a plurality of blocks occupying only one pixel or few pixels on the imaging plane at an edge of the visible range, a degree of detail of the block farther from the virtual camera needs to be lower.

In this embodiment of this application, the computer device persistently loads, in response to the virtual terrain rendering instruction, the virtual block in the entire virtual terrain at the first level of detail (that is, a level of detail having the lowest degree of detail) into the memory. Subsequently, the target level of detail of each visible virtual block within the visible range needs to be determined based on the orientation of the virtual camera, and target levels of detail of different virtual blocks may be determined based on projection distances between the virtual blocks and the virtual camera according to the imaging principle where closer objects appear larger and farther objects appear smaller.

In some embodiments, the computer device determines the projection distance between each visible virtual block and the virtual camera within the visible range based on the orientation of the virtual camera. For each visible virtual block, the projection distance between the visible virtual block and the virtual camera is determined based on the orientation of the virtual camera.

In some embodiments, for the projection distance between each visible virtual block and the virtual camera within the visible range, the visible virtual block and the virtual camera may be placed in a space coordinate system, a center of the virtual camera is used as an origin of the coordinate system, and three-dimensional coordinates in the virtual terrain in the coordinate system are converted into point coordinates in the imaging plane through a projection matrix. The projection distance is a straight-line distance between the visible virtual block and the virtual camera in the space coordinate system. A visible virtual block farther from the camera corresponds to a larger projection distance, and a visible virtual block closer to the camera corresponds to a smaller projection distance.

Subsequently, the target level of detail of each visible virtual block within the visible range is determined based on the projection distance corresponding to each visible virtual block. For each visible virtual block, the target level of detail of the visible virtual block is determined based on the projection distance between the visible virtual block and the virtual camera.

A degree of detail represented by the target level of detail is negatively correlated to the projection distance. In other words, a larger corresponding projection distance of the visible virtual block indicates a lower degree of detail represented by the target level of detail, and a smaller corresponding projection distance of the visible virtual block indicates a higher degree of detail represented by the target level of detail. In the foregoing manner, the determined target level of detail of the visible virtual block is more accurate.

Projected areas occupied by different blocks within the visible range projected onto the imaging plane may be different. Therefore, in a process of determining a target level of detail, a pixel threshold may be set. The pixel threshold represents the same level of detail of blocks that are projected within a quantity of pixels indicated by the pixel threshold. Therefore, different pixel thresholds may be set to satisfy requirements on different degrees of detail for rendering a virtual terrain. A smaller pixel threshold indicates a more detailed virtual terrain finally presented on the imaging plane and a better imaging effect.

For example, FIG. 5 is a schematic diagram of imaging effects of different blocks within a visible range on an imaging plane according to an exemplary embodiment of this application. A size of a first virtual block 501 and a size of a second virtual block 502 are the same, and are both S. Due to the orientation of the virtual camera, a projection distance D1 to the first virtual block 501 is less than a projection distance D2 to the second virtual block 502. A projected area of the first virtual block 501 on an imaging plane 503 is S1, and a projected area of the second virtual block 502 on the imaging plane 503 is S2. Since a projection distance corresponding to the first virtual block 501 is smaller, the projected area S1 of the first virtual block 501 projected onto the imaging plane 503 is greater than the projected area S2 of the second virtual block 502 projected onto the imaging plane 503.

In this embodiment of this application, the computer device determines a reference projection distance based on projected areas of different visible virtual blocks on the imaging plane and a pixel threshold.

The pixel threshold is a pixel error, and a projected area of a visible virtual block whose distance to the virtual camera is less than the reference projection distance on the imaging plane is greater than the pixel threshold.

In some embodiments, the computer device calculates the projected areas of different visible virtual blocks on the imaging plane, compares the projected areas with the pixel threshold, determines a visible virtual block whose projected area is equal to the pixel threshold, and determines a projection distance corresponding to the visible virtual block as the reference projection distance.

In some embodiments, the computer device may calculate the reference projection distance based on the set pixel threshold according to a formula for calculating a reference projection distance. The following is the formula for calculating a reference projection distance:

$$d = \frac{0.5 {R}_{n} \cdot T}{E \cdot tan ( 0.5 F o {V}_{y} )}$$

Rₙ is a resolution of a projection plane, T is a size of the virtual block, E is the set pixel threshold, and FoV_{y} indicates an included angle of a frustum. Based on the foregoing formula, the computer device may determine the reference projection distance based on a pixel threshold set by a user.

In some embodiments, to optimize an imaging effect, the pixel threshold may be set to 1 pixel.

Subsequently, the computer device determines target levels of detail of the different visible virtual blocks based on a projection distance corresponding to each visible virtual block within a visible range and a ratio relationship between the projection distance and the reference projection distance.

In a possible implementation, different levels of detail of the visible virtual block respectively correspond to different levels of a quadtree structure, where the quadtree structure includes m levels, a first level of detail corresponds to a first level of the quadtree structure, and m is an integer greater than 1.

It is assumed that a complete terrain grid includes M×N virtual blocks, where M and N are arbitrary positive integers. One virtual block includes B×B virtual tiles, where B is a non-negative integer power of 2. Each virtual tile corresponds to a heightmap with a resolution of H×H and a terrain texture map with a resolution of D×D, where both H and D are integer powers of 2 plus 1.

In some embodiments, the quadtree structure is constructed starting from one virtual block. The quadtree structure includes m levels in total, and a first level corresponds to the virtual block, that is, includes 1×1 virtual tiles. A second level corresponds to four virtual tiles, an m^{th} level corresponds to 4\hat{ }(m−1) virtual tiles, and a size of the virtual tile corresponding to the m^{th} level is 1/[4\hat{ }(m−1)] of the size of the virtual tile corresponding to the first level. In addition, resolutions of heightmaps and texture maps corresponding to virtual tiles of different levels are the same.

Each virtual tile may correspond to a plurality of heightmaps or texture maps. This is not limited in this embodiment.

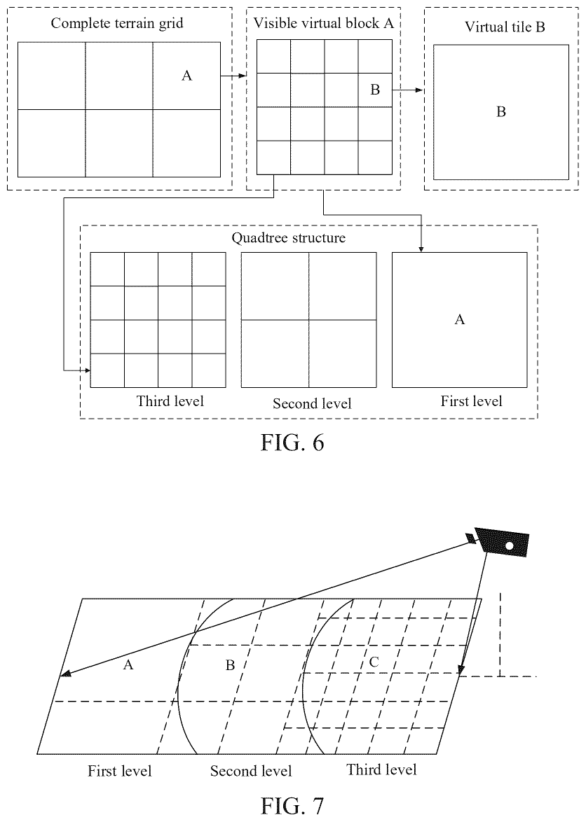

For example, FIG. 6 is a schematic diagram of a quadtree structure according to an exemplary embodiment of this application. M=3, N=2, and B=4. In this case, a complete terrain grid includes six visible virtual blocks, and a virtual block A includes 16 virtual tiles, for example, virtual tile B included in the visible virtual block A in the figure. In addition, in the created quadtree structure, the first level corresponds to the visible virtual block A, the second level corresponds to four virtual tiles, and a third level corresponds to 16 virtual tiles.

In the quadtree structure, when the projection distance corresponding to the visible virtual block is exactly equal to the reference projection distance, the projected area of the block in the projection plane is equal to the pixel threshold. A projected area of a block whose corresponding projection distance is less than the reference projection distance in the projection plane needs to be greater than the projection plane. When the projected area corresponding to the visible virtual block is exactly equal to half of the reference projection distance, the projected area of the visible virtual block in the projection plane needs to be equal to four times the pixel threshold, and corresponds to the second level of the quadtree structure, and one pixel threshold may correspond to one virtual sub-module. However, when the projection plane corresponding to the visible virtual block is exactly equal to one fourth of the reference projection distance, the projected area of the visible virtual block in the projection plane needs to be equal to sixteen times the pixel threshold, and corresponds to the third level of the quadtree structure, and one pixel threshold may correspond to one more detailed virtual sub-module. Therefore, a target level of detail corresponding to the visible virtual block in the quadtree structure may be determined based on the projection distance corresponding to the virtual block.

When the projection distance corresponding to the visible virtual block is greater than or equal to the reference projection distance, it is determined that the target level of detail of the visible virtual block is a level of detail corresponding to the first level of the quadtree structure, that is, it is determined that the target level of detail of the visible virtual block is the first level of detail.

When the projection distance corresponding to the visible virtual block is greater than the reference projection distance or is exactly equal to the reference projection distance, it indicates that the visible virtual block is far from the virtual camera, and the projected area of the visible virtual block on the imaging plane is less than the pixel threshold. Therefore, terrain rendering may be performed based on virtual terrain data of the visible virtual block at the first level of detail having low degree of detail. Since the projected area of the projection plane is small, using the virtual terrain data at the first level of detail to perform terrain rendering does not affect a final imaging effect.

When a ratio of the projection distance corresponding to the visible virtual block to the reference projection distance is less than 1/[2\hat{ }(n−1)] times the reference projection distance and is greater than or equal to 1/(2\hat{ }n) times the reference projection distance, it is determined that the target level of detail of the visible virtual block is a level of detail corresponding to an (n+1)^{th} level of the quadtree structure.

n is greater than or equal to 1, and n is less than or equal to m. When n is equal to 1, the projection distance between the visible virtual block and the virtual camera is equal to the reference projection distance, and the visible virtual block corresponds to the first level of detail.

For example, when n=2, and the ratio of the projection distance corresponding to the visible virtual block to the reference projection distance is less than ½ of the reference projection distance and is greater than or equal to ¼ of the reference projection distance, it is determined that the target level of detail of the visible virtual block is a level of detail corresponding to the third level of the quadtree structure.

When n=1, and the ratio of the projection distance corresponding to the visible virtual block to the reference projection distance is less than 1 and is greater than or equal to ½ of the reference projection distance, it is determined that the target level of detail of the visible virtual block is a level of detail corresponding to the second level of the quadtree structure.

When the projection distance corresponding to the visible virtual block is less than 1/[2\hat{ }(m−1)] times the reference projection distance, it is determined that the target level of detail of the visible virtual block is a level of detail corresponding to the m^{th} level of the quadtree structure.

As the distance between the visible virtual block and the virtual camera gradually decreases, a degree of detail represented by the target level of detail corresponding to the visible virtual block needs to continuously increase, but a set quantity of levels of the quadtree is limited. Therefore, after the target level of detail corresponding to the visible virtual block corresponds to the highest level of the quadtree, a target level of detail closer to the visible virtual block corresponds to the m^{th} level of the quadtree structure.

For example, when m=3, that is, there are three levels in total in the quadtree structure, and the projection distance corresponding to the visible virtual block is less than ¼ of the reference projection distance, it is determined that the target level of detail of the visible virtual block is the level of detail corresponding to the third level of the quadtree structure.

For example, FIG. 7 is a schematic diagram of target levels of detail of visible virtual blocks at different projection distances according to an exemplary embodiment of this application. Corresponding to the quadtree structure shown in FIG. 6, the quadtree structure includes three visible virtual blocks of different target levels of detail in total. If the projection distance corresponding to the visible virtual block in a region A is greater than the reference projection distance, the visible virtual block corresponds to the level of detail corresponding to the first level of the quadtree structure. If the ratio of the projection distance corresponding to the visible virtual block in a region B to the reference projection distance is less than 1 and greater than ½ of the reference projection distance, the target level of detail corresponds to the level of detail corresponding to the second level of the quadtree structure. If the ratio of the projection distance corresponding to the visible virtual block in a region C to the reference projection distance is less than ¼ of the reference projection distance, the target level of detail corresponds to the level of detail corresponding to the third level of the quadtree structure.

In this embodiment of this application, the reference projection distance is determined based on different set pixel thresholds, so that a degree of detail of the virtual terrain that needs to be generated can be controlled. In addition, target levels of detail corresponding to visible virtual blocks at different projection distances are determined based on the reference projection distance, thereby achieving a better imaging effect and improving visual experience of a user. This method is applicable to various virtual terrain rendering scenarios.

When the target levels of detail of the different visible virtual blocks are determined, the computer device needs to generate the virtual terrain based on the virtual terrain data at the target levels of detail of the different visible virtual blocks, and needs to access the virtual terrain data loaded into the memory during the virtual terrain generation.

When the virtual terrain data of the visible virtual block at the target level of detail is present in the memory, the virtual terrain data of the visible virtual block at the target level of detail is accessed for virtual rendering.

When no virtual terrain data of the visible virtual block at the target level of detail is present in the memory, the virtual terrain data of the visible virtual block at the target level of detail is dynamically loaded into the memory.

In some embodiments, due to limited storage space of the memory, when the virtual terrain data occupies a large amount of memory space, operational performance of the computer device may be degraded, resulting in latency. Therefore, a dynamic loading threshold, that is, an upper limit of the memory space for dynamically loading the virtual terrain data into the memory, may be set.

When the virtual terrain data of the visible virtual block at the target level of detail needs to be loaded, first, a loading memory requirement of the virtual terrain data of the visible virtual block at the target level of detail is determined.

Subsequently, the computer device determines whether a sum of the dynamically loaded virtual terrain data and the loading memory requirement reaches the upper limit of the memory space.

The dynamic loading threshold is an upper limit of the storage space divided in the memory that is configured for dynamically loading the virtual terrain data. The dynamically loaded virtual terrain data cannot be loaded into another memory space. In addition, the dynamically loaded virtual terrain data is not immediately unloaded after terrain rendering is performed, but is temporarily kept in the memory.

When a sum of the loading memory requirement and memory space occupied by the dynamically loaded virtual terrain data does not reach the dynamic loading threshold, the virtual terrain data of the visible virtual block at the target level of detail is dynamically loaded into the memory.

When the sum of the loading memory requirement and memory occupied by the dynamically loaded virtual terrain data does not reach the dynamic loading threshold, virtual terrain data of the most recently loaded visible virtual block at the target level can be directly loaded into the memory.

When the sum of the loading memory requirement and the memory space occupied by the dynamically loaded virtual terrain data reaches the dynamic loading threshold, the computer device unloads the target virtual terrain data from the memory, and then dynamically loads the virtual terrain data of the visible virtual block at the target level of detail into the memory.

The target virtual terrain data is the dynamically loaded virtual terrain data.

In a possible implementation, the target virtual terrain data may be determined from the loaded virtual terrain data according to the least recently used principle.

In some embodiments, a memory queue exists in the memory, and is configured for storing the dynamically loaded virtual terrain data. In addition, the most recently loaded virtual terrain data is located at the head of the memory queue, that is, virtual terrain data that is loaded to a current frame is located at the head of the memory queue. For example, in a process of loading a first frame, loaded first terrain data is located at the head of the memory queue. In a process of loading a second frame, the computer device loads second terrain data, and the second terrain data is located at the head of the memory queue. Levels of detail of the first terrain data and the second terrain data are greater than the first level of detail.

When the virtual terrain data of the visible virtual block at the target level of

detail needs to be loaded, and no virtual terrain data of the visible virtual block at the target level of detail is present in the memory, the virtual terrain data is loaded to the head of the memory queue.

When the virtual terrain data of the visible virtual block at the target level of detail needs to be loaded, and the virtual terrain data of the visible virtual block at the target level of detail is present in the memory, the virtual terrain data of the visible virtual block at the target level of detail in the memory queue is accessed, and the virtual terrain data is filled to the head of the memory queue.

When the virtual terrain data is managed in the foregoing manner, in the memory queue, the least recently used virtual terrain data is certainly located at the tail of the memory queue, so that virtual terrain data located at the tail of the memory queue may be determined as the target virtual terrain data.

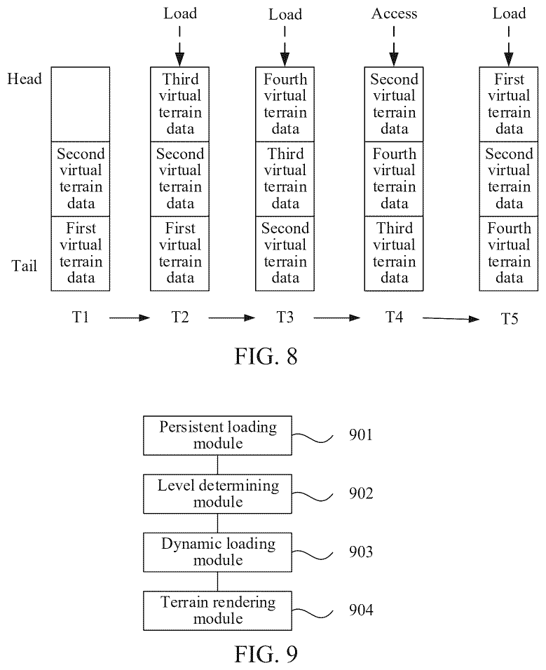

FIG. 8 is a schematic diagram of dynamically loading virtual terrain data according to an exemplary embodiment of this application. It is assumed that three groups of virtual terrain data can be loaded into the memory queue, the most recently loaded virtual terrain data is located at the head of the memory queue. At a moment T1, there is no data stored at the head of the memory queue. Third virtual terrain data loaded at a moment T2 is directly stored to the head of the memory queue. At a moment T3, fourth virtual terrain data is loaded. In this case, the storage space of the memory queue is full. The first virtual terrain data located at the tail of the queue is determined as the target virtual terrain data, and is unloaded. Subsequently, the fourth virtual terrain data is loaded into the memory queue. At a moment T4, when the loaded second virtual terrain data is accessed, the second virtual terrain data is moved to the head of the memory queue. At a moment T5, the first virtual terrain data needs to be re-loaded. Since the memory queue is full, the third virtual terrain data is determined as the target virtual terrain data, and the first virtual terrain data is loaded after the third virtual terrain data is unloaded.

In this embodiment of this application, the virtual terrain data of the visible virtual block at the target level of detail is dynamically loaded, and a memory budget is set to balance a rendering effect and rendering performance of the virtual terrain, so that the user can set the memory budget to achieve a desired terrain rendering effect.

In addition, in some implementations, levels of detail of the same visible virtual block under different perspectives are different. Therefore, frequent switching of the perspective of the virtual camera within a short time may cause visible flickering of multi-level of detail switching. However, the dynamically loaded virtual terrain data is managed by using the least recently used strategy, when the camera perspective frequently switches within a short time, the virtual terrain data of the different visible virtual blocks at the target level of detail is dynamically loaded into the memory. As a result, the loaded virtual terrain data at the target level of detail is directly accessed from the memory during terrain rendering, thereby avoiding visible flickering caused by multi-level of detail changes due to camera perspective switching.

In this embodiment of this application, the visible virtual block includes virtual tiles, when the target levels of detail of the visible virtual block are different, sizes of the included virtual tiles are different, and the virtual terrain data of the visible virtual block at the target level of detail matches virtual terrain data of the virtual tiles included in the visible virtual block at the target level of detail.

A higher degree of detail represented by the target level of detail indicates smaller sizes of the corresponding virtual tiles.

Since resolutions of heightmaps and texture maps corresponding to virtual tiles of different sizes are the same, the virtual tile with a smaller size has a higher degrees of detail.

When virtual terrain rendering is performed based on the virtual terrain data of each visible virtual block at the respective target level of detail in the memory, in practice, virtual terrain data corresponding to the virtual tile having the smallest size is used at a near end of the virtual camera, and virtual terrain data corresponding to the virtual tile having the largest size is used at a far end of the virtual camera.

In a virtual terrain rendering process, when the target level of detail of the

visible virtual block is the first level of detail, a virtual terrain of a first region is rendered based on the virtual terrain data of the visible virtual block at the first level of detail.

When the target level of detail of the visible virtual block is not the first level of detail, a virtual terrain of a second region is rendered based on the virtual terrain data of the virtual tiles included in the visible virtual block at the target level of detail, the first region and the second region constituting the visible range.

In other words, after the target level of detail is determined, virtual terrains of different virtual tiles are rendered based on virtual terrain data of virtual tiles corresponding to different determined target levels of detail, to obtain a complete visible range.

Since the virtual terrain data of each visible virtual block at the first level of detail is persistently loaded into the memory, when it is determined that the target level of detail is the first level of detail of the visible virtual block, and terrain rendering is performed, the computer device invokes, from the persistent memory, the virtual terrain data of the visible virtual block at the first level of detail, to render the virtual terrain.

The computer device needs to render the virtual terrain based on terrain meshes. In this embodiment of this application, the visible virtual block and the virtual tiles correspond to the same terrain mesh.

In a terrain rendering process, position and scaled sizes of meshes corresponding to each virtual block are adjusted based on the virtual terrain data corresponding to the visible virtual block at the target level of detail.

In some embodiments, the computer device adjusts a rendering position of the terrain mesh and adjusts a size of the terrain mesh based on the virtual terrain data at the first level of detail, and then applies a terrain texture map and a heightmap included in the virtual terrain data at the first level of detail on the terrain mesh corresponding to the visible virtual block, to render the virtual terrain of the first region.

The adjusted terrain mesh covers a surface of the visible virtual block.

The terrain rendering process is a process of applying feature information such as the heightmap and the texture image to the terrain mesh.

In addition, the rendering position of the terrain mesh is adjusted and the size of the terrain mesh is adjusted based on the virtual terrain data of the virtual tiles included in the visible virtual block at the target level of detail. Subsequently, a terrain texture map and a heightmap included in the virtual terrain data of the virtual tiles are applied to the terrain meshes corresponding to the virtual tiles, to render the virtual terrain of the second region.

The adjusted terrain mesh covers the surface of the virtual tiles.

Sizes of the virtual tiles at different levels are different. Therefore, the mesh needs to be scaled to make the size of the mesh correspond to the size of the virtual tile, so that the terrain mesh covers the surface of the virtual block.

After the heightmap and the texture image that have the same resolution as the resolution of the visible virtual block are applied on a smaller terrain mesh, the rendered virtual terrain has a higher degree of detail.

In addition to the included heightmap and terrain texture map, the virtual terrain data may further include other feature information such as a normal map. This is not limited in this embodiment.

In this embodiment of this application, based on the virtual terrain data of the visible virtual block at the different target levels of detail, description data configured for describing information such as the position of the visible virtual block in the virtual terrain information is stored in a cache region of a graphics processing unit (GPU), and texture data corresponding to the visible virtual block is stored in a texture data array of the GPU. In response to the virtual terrain rendering instruction, the computer device maintains the virtual terrain data in each frame, so that rendering of the entire terrain can be completed by using only one rendering application programming interface (API) command, thereby effectively reducing interrupts, reducing involvement of a central processing unit (CPU) in terrain rendering, and improving hardware resource utilization.

In a possible implementation, after determining the target level of detail of the visible virtual block, the computer device records target levels of detail of adjacent visible virtual blocks.

Since terrain meshes used by the visible virtual block and the virtual tiles corresponding to the different levels of detail are consistent, when the target levels of detail of the adjacent visible virtual blocks are different, vertices of terrain meshes corresponding to the adjacent visible virtual blocks do not correspond to each other, and gaps may exist in the generated virtual terrain. Therefore, the terrain meshes need to be adjusted, to avoid gaps between different visible virtual blocks.

In some embodiments, when the target levels of detail of the adjacent visible virtual blocks are different, vertices of terrain meshes of virtual tiles at different levels of detail are adjusted based on the different target levels of detail of the visible virtual blocks, adjusted vertex positions of terrain meshes corresponding to the adjacent visible virtual blocks matching each other, to eliminate gaps between the adjacent visible virtual blocks.

In some embodiments, when the target levels of detail of the adjacent visible virtual blocks are different, vertices on edges of a terrain mesh of a virtual tile at a higher level of detail are moved to vertices of a terrain mesh of a virtual tile at a lower level of detail.

In some embodiments, when the target levels of detail of the adjacent visible virtual blocks are different, before the terrain meshes are adjusted, a terrain mesh of a virtual tile at a high level of detail is first determined as a base mesh. Since the terrain mesh at the high level of detail has more vertices, a vertex of a low detail terrain mesh that corresponds to each vertex in the base mesh may be first determined in a process of adjusting the vertices of the terrain mesh. Subsequently, the computer device calculates an interpolation weight of each vertex of the terrain mesh at the low level of detail between vertices of adjacent base meshes. Finally, interpolation is performed on a position of a vertex on the terrain mesh of a low level of detail based on positions of adjacent vertices on the base mesh by using the interpolation weight. For example, weighted averaging may be performed on positions of adjacent vertices on the base mesh based on the weight by using a linear interpolation method.

In this embodiment of this application, when the target levels of detail of the adjacent visible virtual blocks are different, vertices of the terrain mesh are adjusted to eliminate the gaps between the adjacent visible virtual blocks, so that the virtual terrain transition between the virtual blocks is more natural.

In some embodiments, scattered light on an object surface is simulated by using a technology such as a physical lighting shading technology or global lighting technology, thereby achieving the terrain rendering effect with near-natural realism.

In a terrain rendering process based on the target level of detail, a color of a terrain surface is calculated based on an angle and a distance of the terrain surface relative to the virtual camera. To ensure realistic shading, a shading algorithm based on physical modeling may be used.

In some embodiments, in a process of determining the color of the terrain surface, first, a normal vector at each sampling point in the virtual terrain is calculated. The normal vector represents a direction of the terrain surface at the sampling point. The normal vector may be calculated by using a heightmap or a height difference between adjacent sampling points. Subsequently, the computer device calculates lighting intensity corresponding to each sampling point based on a position and intensity of a light source and the normal vector of the sampling point. In addition, in a lighting shading process, a material of the virtual terrain also affects the color of the terrain surface, and the color of the surface of the virtual terrain and lighting reflection may be adjusted based on material attributes of different materials of different virtual terrains. In addition, to make the virtual terrain more realistic, the lighting shading can further produce a shadow effect, and a shadow of the terrain surface may be calculated by using a shadow rendering technology. Finally, the computer device performs operations such as lighting intensity calculation, material shading, and shadow rendering through a shader of the virtual terrain, thereby achieving the rendering of the virtual terrain.

In a process of the virtual camera capturing the virtual terrain, the brightness of the light reflected from the terrain surface depends on an observation angle, and surfaces of different materials have different light reflective properties, so that the computer device may shade the virtual terrain according to a bidirectional reflectance distribution function, a reflection equation, and a rendering equation in the virtual terrain rendering process, so that the rendered terrain can achieve a more realistic effect.

In some embodiments, in a physical lighting shading process, light may be first emitted from a lighting position, and the light is observed. Since the surfaces of the terrains of different materials have different reflective properties for light, after observing the light colliding with an object on the terrain surface, the computer device calculates material properties such as a normal direction of the surface, reflectivity, and a refractive index, and determines the light propagation based on a light propagation direction and the material properties of the terrain surface, to determine the bidirectional reflectance distribution function. The bidirectional reflectance distribution function is a ratio between radiance and irradiance. The bidirectional reflection distribution function is configured for describing the distribution of incident light from different directions on the terrain surface. Subsequently, a ratio of diffuse reflection to specular reflection in a light reflection process is determined according to the Fresnel equation, a color of a shading point is determined according to the reflection equation, and finally, the virtual terrain of the virtual block is shaded according to the rendering equation.

In this embodiment of this application, a physical lighting shading technology is used to render the terrain, so that the rendered virtual terrain can have a more realistic effect. In addition, by integrating high-precision global terrain data, a virtual terrain that approximates a real global terrain can be rendered, resulting in an enhanced terrain rendering effect.

In another possible implementation, the computer device supports customizing the virtual terrain in the virtual terrain rendering process, that is, a customized building in a specified virtual block may be rendered by modifying the virtual terrain data of the different visible virtual blocks. For example, in a flight simulator application, a building such as a virtual airport may need to be rendered at a specified position. Therefore, a virtual airport may be rendered on a specified block, and subsequently, terrain meshes of adjacent virtual blocks are adjusted, to eliminate gaps between the virtual airport and the virtual terrain in surrounding blocks.

In another possible implementation, the computer device supports performing digging processing on a specified position in the virtual terrain rendering process. In the terrain rendering process by using high-precision global terrain data, some regions may not be suitable for virtual terrain rendering, and the computer device performs terrain rendering based on a heightmap in the high-precision global terrain data. In this case, some height data in the heightmap of some visible virtual blocks may be set to specified values, and when the computer device detects the specified values in the heightmap, the computer device does not render the blocks in the region, thereby enabling hole carving in the virtual terrain.

The solutions provided in this embodiment of this application can enable hole carving in the virtual terrain, ensuring privacy of some regions in the virtual terrain rendering process based on real global terrain data, and further providing a function of customizing the virtual terrain for the user. The virtual terrain rendering solution provided in this embodiment of this application is beneficial to improving integration of a customized virtual terrain and an existing global virtual terrain.

FIG. 9 is a structural block diagram of a virtual terrain rendering apparatus according to an exemplary embodiment of this application. As shown in FIG. 9, the apparatus includes the following structures:

a persistent loading module 901, configured to: persistently load, in response to a virtual terrain rendering instruction, virtual terrain data of a virtual block in a virtual terrain at a first level of detail into a memory, the virtual block having virtual terrain data at at least two levels of detail, and a degree of detail represented by the first level of detail being lower than a degree of detail represented by another level of detail; a level determining module 902, configured to determine a target level of detail of each of at least one visible virtual block based on an orientation of a virtual camera, the visible virtual block being a virtual block located within a visible range of the virtual camera; a dynamic loading module 903, configured to: dynamically load, for each visible virtual block, when no virtual terrain data of the visible virtual block at the target level of detail is present in the memory, the virtual terrain data of the visible virtual block at the target level of detail into the memory; and a terrain rendering module 904, configured to render the virtual terrain based on the virtual terrain data of each visible virtual block at the respective target level of detail in the memory.

In some embodiments, the dynamic loading module 903 is configured to determine a loading memory requirement of the virtual terrain data of the visible virtual block at the target level of detail; unload target virtual terrain data from the memory when a sum of the loading memory requirement and memory space occupied by the dynamically loaded virtual terrain data reaches a dynamic loading threshold, the target virtual terrain data being dynamically loaded virtual terrain data; dynamically load the virtual terrain data of the visible virtual block at the target level of detail into the memory; and dynamically load the virtual terrain data of the visible virtual block at the target level of detail into the memory when the sum of the loading memory requirement and the memory space occupied by the dynamically loaded virtual terrain data does not reach the dynamic loading threshold.

In some embodiments, the memory has a memory queue, the memory queue being configured for storing the dynamically loaded virtual terrain data, and the most recently loaded virtual terrain data being located at the head of the memory queue. The dynamic loading module 903 is further configured to determine virtual terrain data located at the tail of the memory queue as the target virtual terrain data.

In some embodiments, the level determining module 902 is configured to: determine, for each visible virtual block, a projection distance between the visible virtual block and the virtual camera based on the orientation of the virtual camera; and determine the target level of detail of the visible virtual block based on the projection distance, a degree of detail represented by the target level of detail being negatively correlated to the projection distance.

In some embodiments, the level determining module 902 is configured to determine a reference projection distance based on a projected area of the visible virtual block on an imaging plane and a pixel threshold, when the distance between the visible virtual block and the virtual camera is less than the reference projection distance, the projected area of the visible virtual block on the imaging plane being greater than the pixel threshold; and determine the target level of detail of the visible virtual block based on the projection distance and a ratio relationship between the projection distance and the reference projection distance.

In some embodiments, different levels of detail of the visible virtual block respectively correspond to different levels of a quadtree structure, the quadtree structure including m levels, the first level of detail corresponding to a first level of the quadtree structure, and m being an integer greater than 1; and the level determining module 902 is configured to: determine, when the projection distance is greater than or equal to the reference projection distance, that the target level of detail of the visible virtual block is the first level of detail; determine, when a ratio of the projection distance to the reference projection distance is less than 1/[2\hat{ }(n−1)] times the reference projection distance and is greater than or equal to 1/(2\hat{ }n) times the reference projection distance, that the target level of detail of the visible virtual block is a level of detail corresponding to an (n+1)^{th} level of the quadtree structure, n being greater than or equal to 1, n being less than or equal to m, when n is equal to 1, the projection distance between the visible virtual block and the virtual camera is equal to the reference projection distance, and the target level of detail of the visible virtual block being the first level of detail; and determine, when the projection distance corresponding to the visible virtual block is less than 1/[2\hat{ }(m−1)] times the reference projection distance, that the target level of detail of the visible virtual block is a level of detail corresponding to an m^{th} level of the quadtree structure.

In some embodiments, the visible virtual block includes virtual tiles, when target levels of detail of the visible virtual block are different, sizes of the included virtual tiles are different, and the virtual terrain data of the visible virtual block at the target level of detail matches virtual terrain data of the virtual tiles included in the visible virtual block at the target level of detail.

In some embodiments, the terrain rendering module 904 is configured to: render, when the target level of detail of the visible virtual block is the first level of detail, a virtual terrain of a first region based on virtual terrain data of the visible virtual block at the first level of detail; and render, when the target level of detail of the visible virtual block is not the first level of detail, a virtual terrain of a second region based on the virtual terrain data of the virtual tiles included in the visible virtual block at the target level of detail, the first region and the second region constituting the visible range.

In some embodiments, the visible virtual block and the virtual tiles correspond to the same terrain mesh.

The terrain rendering module 904 is configured to adjust a rendering position of the terrain mesh and adjust a size of the terrain mesh based on the virtual terrain data at the first level of detail, the adjusted terrain mesh covering a surface of the visible virtual block; apply a terrain texture map and a heightmap included in the virtual terrain data at the first level of detail to the terrain mesh corresponding to the visible virtual block, to render the virtual terrain of the first region; adjust the rendering position of the terrain mesh and adjusting the size of the terrain mesh based on the virtual terrain data of the virtual tiles included in the visible virtual block at the target level of detail, the adjusted terrain mesh covering a surface of the virtual tiles; and apply a terrain texture map and a heightmap included in the virtual terrain data of the virtual tiles to the terrain meshes corresponding to the virtual tiles, to render the virtual terrain of the second region.

In some embodiments, the apparatus further includes a terrain mesh adjustment module, configured to record target levels of detail of adjacent visible virtual blocks; and adjust, when the target levels of detail of the adjacent visible virtual blocks are different, vertices of terrain meshes of virtual tiles at different levels of detail based on the different target levels of detail of the visible virtual blocks, adjusted vertex positions of the terrain meshes corresponding to the adjacent visible virtual blocks matching each other, to eliminate gaps between the adjacent visible virtual blocks.

In conclusion, in this embodiment of this application, in a virtual terrain loading process, virtual terrain data of all virtual blocks in the virtual terrain at the first level of detail having the lowest degree of detail is persistently loaded into the memory, and after the target level of detail of each visible virtual block within the visible range is determined, virtual terrain data of each visible virtual block at the target level of detail is dynamically loaded into the memory. The virtual terrain data of the virtual block at the first level of detail is persistently loaded, and the virtual terrain data of the visible virtual block at the target level of detail is dynamically loaded. Loading virtual terrain data of different blocks at different levels of detail in this asynchronous dynamic loading manner is beneficial to dynamically adjusting the degree of detail of the generated virtual terrain based on the orientation of the virtual camera in the virtual terrain loading process, which better conforms to the way the human eye perceives objects in reality. In addition, the asynchronous dynamic loading manner for the virtual terrain data achieves a higher degree of intelligence compared with pre-loading virtual terrain information on fixed routes and determining terrain meshes, and the terrain loading solution achieves wider usage scenarios.

The apparatus provided in the foregoing embodiment is merely described by using the division of the foregoing functional modules as an example. In actual application, the functions may be allocated to and completed by different functional modules according to requirements. In other words, an internal structure of the apparatus is divided into different functional modules, to complete all or some of the functions described above. In addition, the apparatus provided in the foregoing embodiment and the method embodiments belong to the same concept. For an implementation process, refer to the method embodiments. Details are not described herein again.

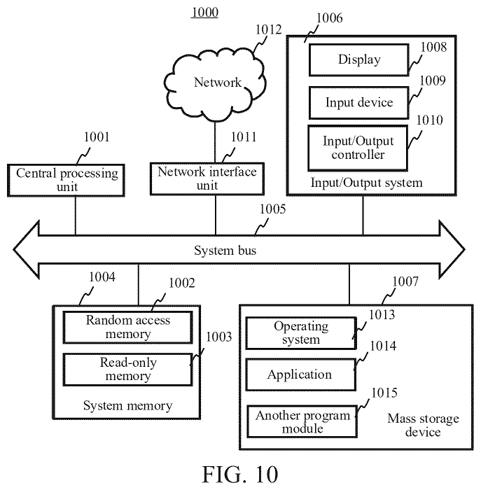

FIG. 10 is a schematic structural diagram of a computer device according to an exemplary embodiment of this application. The computer device may be implemented as the terminal or the server in the foregoing embodiments. Specifically, the computer device 1000 includes a central processing unit (CPU) 1001, a system memory 1004 including a random access memory 1002 and a read-only memory 1003, and a system bus 1005 connecting the system memory 1004 and the central processing unit 1001. The computer device 1000 further includes a basic input/output system (I/O system) 1006 assisting in transmitting information between components in a computer, and a mass storage device 1007 configured for storing an operating system 1013, an application 1014, and another program module 1015.

In some embodiments, the basic I/O system 1006 includes a display 1008 configured for displaying information and an input device 1009, such as a mouse or a keyboard, configured to input information by a user. The display 1008 and the input device 1009 are both connected to the central processing unit 1001 through an input and output controller 1010 connected to the system bus 1005. The basic I/O system 1006 may further include the input and output controller 1010, to receive and process inputs from a plurality of other devices such as a keyboard, a mouse, and an electronic stylus. Similarly, the input and output controller 1010 further provides an output to a display screen, a printer, or another type of output device.

The mass storage device 1007 is connected to the central processing unit 1001 through a mass storage controller (not shown) connected to the system bus 1005. The mass storage device 1007 and an associated computer-readable medium provide non-volatile storage for the computer device 1000. In other words, the mass storage device 1007 may include a computer-readable medium (not shown) such as a hard disk or a drive.

Without a loss of generality, the computer-readable medium may include a computer storage medium and a communication medium. The computer storage medium includes a volatile and non-volatile, removable, and non-removable medium implemented by using any method or technology for storing information such as computer-readable instructions, a data structure, a program module, or another data. The computer storage medium includes a random access memory (RAM), a read-only memory (ROM), a flash memory, or another solid-state storage technology, a compact disc read-only memory (CD-ROM), a digital versatile disc (DVD), or another optical storage, a cassette, a magnetic tape, a disk storage, or another magnetic storage device. Certainly, a person skilled in the art may learn that the computer storage medium is not limited to the foregoing several types. The system memory 1004 and the mass storage device 1007 may be collectively referred to as the memory.

The memory stores a computer program, and the computer program is configured to be executed by one or more central processing units 1001, to implement the foregoing virtual terrain rendering method.

According to various embodiments of this application, the computer device 1000 may also be connected to a remote computer on a network over a network, such as the internet, to run. In other words, the computer device 1000 may be connected to a network 1012 through a network interface unit 1011 connected to the system bus 1005, or may be connected to another type of network or a remote computer system (not shown) through the network interface unit 1011.

Embodiments of this application further provide a non-transitory computer-readable storage medium, the computer-readable storage medium having a computer program stored therein, and the computer program being loaded and executed by a processor to implement the foregoing virtual terrain rendering method.

Embodiments of this application provide a computer program product, the computer program product including a computer program, and the computer program being stored in a non-transitory computer-readable storage medium. A processor of a computer device reads the computer program from the computer-readable storage medium, and the processor executes the computer program, to enable the computer device to perform the foregoing virtual terrain rendering method.

In some embodiments, the computer-readable storage medium may include a ROM, a RAM, a solid state drive (SSD), an optical disc, or the like. The RAM may include a resistance random access memory (ReRAM) and a dynamic random access memory (DRAM). Sequence numbers of the foregoing embodiments of this application are merely for description, and do not indicate superiority or inferiority of the embodiments.

All information (including, but not limited to, user equipment information, user personal information, and the like), data (including, but not limited to, data configured for analysis, stored data, displayed data, and the like), and a signal involved in this application are authorized by a user or fully authorized by all parties, and the collection, use, and processing of relevant data need to comply with the related laws, regulations, and standards of related countries and regions.

In addition, in this application, a prompt interface, a pop-up window, or voice prompt information may be displayed before and during the collection of the relevant data of the user. The prompt interface, the pop-up window, or the voice prompt information is configured for prompting the user that the relevant data of the user is currently being collected. In this application, only after a confirmation operation performed by the user on the prompt interface or the pop-up window is obtained, the relevant operation of obtaining the relevant data of the user starts to be performed. Otherwise (that is, when the confirmation operation performed by the user on the prompt interface or the pop-up window is not obtained), the relevant operation of obtaining the relevant data of the user ends, that is, the relevant data of the user is not obtained.

The “plurality” mentioned in this specification refers to two or more. The term “and/or” in this specification is an association relationship for describing associated objects, and indicates that three relationships may exist. For example, A and/or B may indicate the following three cases: Only A exists, both A and B exist, and only B exists. The character “/” generally indicates an “or” relationship between the associated objects. In addition, “first”, “second”, and the like mentioned in this specification are used to distinguish similar objects, but are not used to limit a specific order or sequence. In addition, operation numbers described in this specification merely shows a possible sequence of performing the operations. In some other embodiments, the foregoing operations may not be performed based on a sequence of the operations. For example, two different numbered operations are performed at the same time, or two operations with different numbers are performed based on a sequence reverse to that shown in the figure. This is not limited in the embodiments of this application.

The above-mentioned descriptions are merely exemplary embodiments of this application, but are not intended to limit this application. Any modification, equivalent replacement, or improvement made without departing from the spirit and principle of this application needs to fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A virtual terrain rendering method performed by a computer device, the method comprising:
in response to a virtual terrain rendering instruction, determining virtual terrain data of a plurality of virtual blocks in a virtual terrain, the virtual terrain data having first and second levels of detail, and a degree of detail represented by the first level of detail being lower than a degree of detail represented by the second level of detail;
determining, among the plurality of virtual blocks, at least one visible virtual block and respective target levels of detail of the at least one visible virtual block based on an orientation of a virtual camera; and
rendering the virtual terrain based on the virtual terrain data of the at least one visible virtual block at the respective target levels of detail.

2. The method according to claim 1, wherein the method further comprises:
dynamically loading, for each visible virtual block, when no virtual terrain data of the visible virtual block at the corresponding target level of detail is present in a memory of the computer device, the virtual terrain data of the visible virtual block at the target level of detail into the memory of the computer device.

3. The method according to claim 2, wherein the dynamically loading the virtual terrain data of the visible virtual block at the target level of detail into the memory comprises:
determining a loading memory requirement of the virtual terrain data of the visible virtual block at the target level of detail;
unloading target virtual terrain data from the memory when a sum of the loading memory requirement and memory space occupied by the dynamically loaded virtual terrain data reaches a dynamic loading threshold, the target virtual terrain data being dynamically loaded virtual terrain data; and dynamically loading the virtual terrain data of the visible virtual block at the target level of detail into the memory; and
dynamically loading the virtual terrain data of the visible virtual block at the target level of detail into the memory when the sum of the loading memory requirement and the memory space occupied by the dynamically loaded virtual terrain data does not reach the dynamic loading threshold.

4. The method according to claim 3, wherein the memory has a memory queue, the memory queue being configured for storing the dynamically loaded virtual terrain data, and the most recently loaded virtual terrain data being located at the head of the memory queue; and
before the unloading target virtual terrain data from the memory, the method further comprises:
determining virtual terrain data located at the tail of the memory queue as the target virtual terrain data.

5. The method according to claim 1, wherein the determining the respective target levels of detail of the at least one visible virtual block based on the orientation of the virtual camera comprises:
determining, for each visible virtual block, a projection distance between the visible virtual block and the virtual camera based on the orientation of the virtual camera; and
determining a target level of detail of the visible virtual block based on the projection distance, a degree of detail represented by the target level of detail being negatively correlated to the projection distance.

6. The method according to claim 5, wherein the determining the target level of detail of the visible virtual block based on the projection distance comprises:
determining a reference projection distance based on a projected area of the visible virtual block on an imaging plane and a pixel threshold, when the distance between the visible virtual block and the virtual camera is less than the reference projection distance, the projected area of the visible virtual block on the imaging plane being greater than the pixel threshold; and
determining the target level of detail of the visible virtual block based on the projection distance and a ratio relationship between the projection distance and the reference projection distance.

7. The method according to claim 1, wherein each visible virtual block comprises virtual tiles, when target levels of detail of the at least one visible virtual block are different, sizes of the corresponding virtual tiles are different, and the virtual terrain data of the visible virtual block at the target level of detail matches virtual terrain data of the virtual tiles comprised in the visible virtual block at the target level of detail.

8. The method according to claim 1, wherein after the determining the respective target levels of detail of the at least one visible virtual block, the method further comprises:
recording target levels of detail of adjacent visible virtual blocks; and
adjusting, when the target levels of detail of the adjacent visible virtual blocks are different, vertices of terrain meshes of virtual tiles at different levels of detail based on the different target levels of detail of the visible virtual blocks, adjusted vertex positions of the terrain meshes corresponding to the adjacent visible virtual blocks matching each other, to eliminate gaps between the adjacent visible virtual blocks.

9. A computer device, comprising a processor and a memory, the memory having a computer program stored therein, the computer program being loaded and executed by the processor and causing the computer device to implement a virtual terrain rendering method including:
in response to a virtual terrain rendering instruction, determining virtual terrain data of a plurality of virtual blocks in a virtual terrain, the virtual terrain data having first and second levels of detail, and a degree of detail represented by the first level of detail being lower than a degree of detail represented by the second level of detail;
determining, among the plurality of virtual blocks, at least one visible virtual block and respective target levels of detail of the at least one visible virtual block based on an orientation of a virtual camera; and
rendering the virtual terrain based on the virtual terrain data of the at least one visible virtual block at the respective target levels of detail.

10. The computer device according to claim 9, wherein the method further comprises:
dynamically loading, for each visible virtual block, when no virtual terrain data of the visible virtual block at the corresponding target level of detail is present in a memory of the computer device, the virtual terrain data of the visible virtual block at the target level of detail into the memory of the computer device.

11. The computer device according to claim 10, wherein the dynamically loading the virtual terrain data of the visible virtual block at the target level of detail into the memory comprises:
determining a loading memory requirement of the virtual terrain data of the visible virtual block at the target level of detail;
unloading target virtual terrain data from the memory when a sum of the loading memory requirement and memory space occupied by the dynamically loaded virtual terrain data reaches a dynamic loading threshold, the target virtual terrain data being dynamically loaded virtual terrain data; and dynamically loading the virtual terrain data of the visible virtual block at the target level of detail into the memory; and
dynamically loading the virtual terrain data of the visible virtual block at the target level of detail into the memory when the sum of the loading memory requirement and the memory space occupied by the dynamically loaded virtual terrain data does not reach the dynamic loading threshold.

12. The computer device according to claim 9, wherein the determining the respective target levels of detail of the at least one visible virtual block based on the orientation of the virtual camera comprises:
determining, for each visible virtual block, a projection distance between the visible virtual block and the virtual camera based on the orientation of the virtual camera; and
determining a target level of detail of the visible virtual block based on the projection distance, a degree of detail represented by the target level of detail being negatively correlated to the projection distance.

13. The computer device according to claim 12, wherein the determining the target level of detail of the visible virtual block based on the projection distance comprises:
determining a reference projection distance based on a projected area of the visible virtual block on an imaging plane and a pixel threshold, when the distance between the visible virtual block and the virtual camera is less than the reference projection distance, the projected area of the visible virtual block on the imaging plane being greater than the pixel threshold; and
determining the target level of detail of the visible virtual block based on the projection distance and a ratio relationship between the projection distance and the reference projection distance.

14. The computer device according to claim 9, wherein each visible virtual block comprises virtual tiles, when target levels of detail of the at least one visible virtual block are different, sizes of the corresponding virtual tiles are different, and the virtual terrain data of the visible virtual block at the target level of detail matches virtual terrain data of the virtual tiles comprised in the visible virtual block at the target level of detail.

15. The computer device according to claim 9, wherein after the determining the respective target levels of detail of the at least one visible virtual block, the method further comprises:
recording target levels of detail of adjacent visible virtual blocks; and
adjusting, when the target levels of detail of the adjacent visible virtual blocks are different, vertices of terrain meshes of virtual tiles at different levels of detail based on the different target levels of detail of the visible virtual blocks, adjusted vertex positions of the terrain meshes corresponding to the adjacent visible virtual blocks matching each other, to eliminate gaps between the adjacent visible virtual blocks.

16. A non-transitory computer-readable storage medium having a computer program stored therein, the computer program being loaded and executed by a processor of a computer device and causing the computer device to implement a virtual terrain rendering method including:
in response to a virtual terrain rendering instruction, determining virtual terrain data of a plurality of virtual blocks in a virtual terrain, the virtual terrain data having first and second levels of detail, and a degree of detail represented by the first level of detail being lower than a degree of detail represented by the second level of detail;
determining, among the plurality of virtual blocks, at least one visible virtual block and respective target levels of detail of the at least one visible virtual block based on an orientation of a virtual camera; and
rendering the virtual terrain based on the virtual terrain data of the at least one visible virtual block at the respective target levels of detail.

17. The non-transitory computer-readable storage medium according to claim 16, wherein the method further comprises:
dynamically loading, for each visible virtual block, when no virtual terrain data of the visible virtual block at the corresponding target level of detail is present in a memory of the computer device, the virtual terrain data of the visible virtual block at the target level of detail into the memory of the computer device.

18. The non-transitory computer-readable storage medium according to claim 17, wherein the dynamically loading the virtual terrain data of the visible virtual block at the target level of detail into the memory comprises:
determining a loading memory requirement of the virtual terrain data of the visible virtual block at the target level of detail;
unloading target virtual terrain data from the memory when a sum of the loading memory requirement and memory space occupied by the dynamically loaded virtual terrain data reaches a dynamic loading threshold, the target virtual terrain data being dynamically loaded virtual terrain data; and dynamically loading the virtual terrain data of the visible virtual block at the target level of detail into the memory; and
dynamically loading the virtual terrain data of the visible virtual block at the target level of detail into the memory when the sum of the loading memory requirement and the memory space occupied by the dynamically loaded virtual terrain data does not reach the dynamic loading threshold.

19. The non-transitory computer-readable storage medium according to claim 16, wherein the determining the respective target levels of detail of the at least one visible virtual block based on the orientation of the virtual camera comprises:
determining, for each visible virtual block, a projection distance between the visible virtual block and the virtual camera based on the orientation of the virtual camera; and
determining a target level of detail of the visible virtual block based on the projection distance, a degree of detail represented by the target level of detail being negatively correlated to the projection distance.

20. The non-transitory computer-readable storage medium according to claim 16, wherein each visible virtual block comprises virtual tiles, when target levels of detail of the at least one visible virtual block are different, sizes of the corresponding virtual tiles are different, and the virtual terrain data of the visible virtual block at the target level of detail matches virtual terrain data of the virtual tiles comprised in the visible virtual block at the target level of detail.
